(19) United States
(12) Patent Application Publication
(10) Pub. No.: US 2020/0328666 A1
(43) Pub. Date: Oct. 15, 2020

(54) METHOD OF FABRICATING COMPOSITE LENS HOLDER, VOICE COIL MOTOR, AND ELECTRONIC DEVICE USING COMPOSITE LENS HOLDER

(71) Applicant: TRIPLE WIN TECHNOLOGY(SHENZHEN) CO.LTD., SHENZHEN (CN)

(72) Inventors: SHIN-WEN CHEN, Tu-Cheng (TW); KUN LI, Shenzhen (CN); HAO-ZHONG LIU, Shenzhen (CN); LONG-FEI ZHANG, Shenzhen (CN)

(73) Assignee: TRIPLE WIN TECHNOLOGY(SHENZHEN) CO.LTD., SHENZHEN (CN)

(21) Appl. No.: 16/441,235

(22) Filed: Jun. 14, 2019

(30) Foreign Application Priority Data
Apr. 11, 2019 (CN) 201910290417.9

(51) Int. Cl. H02K 41/035; G02B 7/02; H02K 3/02; H02K 3/44; H02K 15/04; C23C 18/20; C23C 18/32; C23C 18/42; C23C 18/16

(52) U.S. Cl. CPC H02K 41/0356; G02B 7/02; H02K 3/02; H02K 3/44; C23C 18/1689; C23C 18/204; C23C 18/32; C23C 18/42; H02K 15/0407

(57) ABSTRACT

A method for fabricating a composite lens holder with low-mass conductive metal and high-precision placement thereof to enable smaller-scale fabrication includes the steps of forming a plastic lens holder as a matrix, laser etching an outer surface of the plastic lens holder to form surface patterns, and electroless plating of metal on the surface patterns to form an effective coil, thereby producing the composite lens holder. A voice coil motor and an electronic device which use such a composite lens holder are also disclosed.

### FIELD

The subject matter herein generally relates to optical devices.

### BACKGROUND

As voice coil motors of electronic devices becoming smaller and the plastic lens holders in the motors becoming thinner, the plastic lens holder may become fragile.

Generally, the coil in the voice coil motor is wrapped onto the plastic lens holder using thin copper wire. Traditional wrapped coils have poor reliability. Furthermore, the traditional coils are unstable in torque between the plastic lens holder and the coil, which also affects the performance of the voice coil motor.

Therefore, there is room for improvement.

### BRIEF DESCRIPTION OF THE DRAWINGS

Implementations of the present technology will now be described, by way of embodiments, with reference to the attached figures.

FIG. 1 is a flowchart of a method for fabricating a composite lens holder according to an embodiment.

FIG. 2 is an isometric view of a plastic lens holder according to an embodiment.

FIG. 3 is an isometric view of a composite lens holder according to an embodiment.

FIG. 4 is an isometric view of a voice coil motor according to an embodiment.

FIG. 5 is an isometric view of an electronic device in one embodiment.

### DETAILED DESCRIPTION

The present disclosure is made in conjunction with the accompanying drawings. Specific embodiments of the present disclosure are described.

In the following description, when an element is described as being “fixed to” another element, element can be fixed to another element with or without intermediate elements. When an element is described as “connecting” another element, the element can be connected to the other element with or without intermediate elements, and in a physical or a mechanical way.

Without a given definition otherwise, all terms used have the same meaning as commonly understood by those skilled in the art. The term “and/or” means including any and all combinations of one or more of associated listed items. The terms such as “upper”, “lower”, “left”, “right”, and etc. are only used to indicate the relative positional relationships of objects. When an absolute position of an object to be described is changed, the relative positional relationships of the object to other objects are changed accordingly.

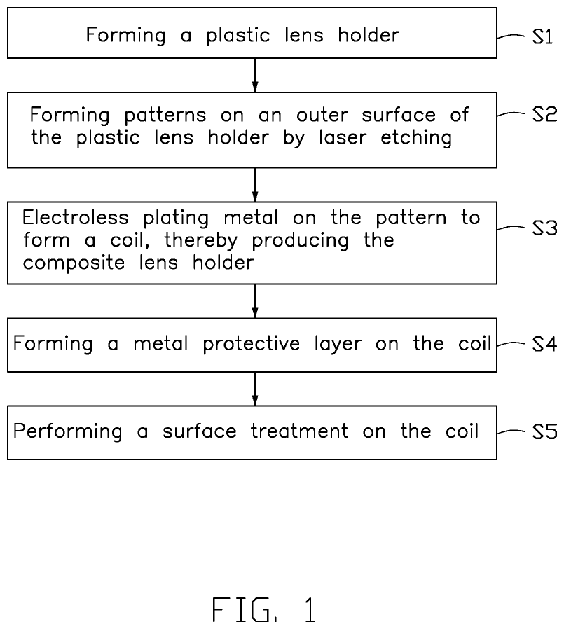

Referring to FIG. 1, an embodiment of the present disclosure provides a method for fabricating a composite lens holder. The method includes the following steps.

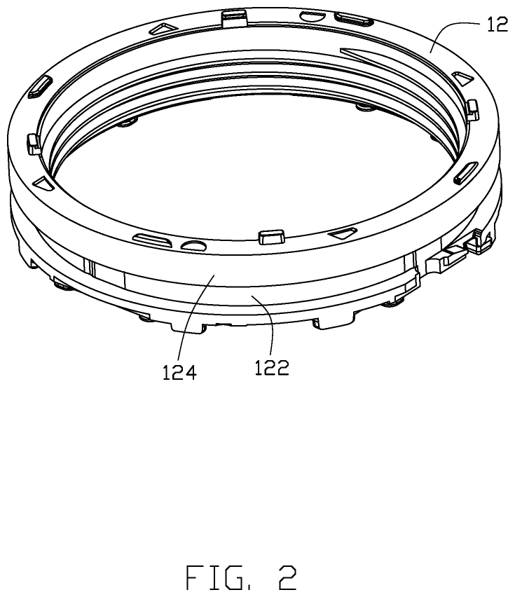

In step S1, forming a plastic lens holder 12. (see FIG. 2).

In step S2, forming patterns 122 (see FIG. 2) on an outer surface 124 of the plastic lens holder 12 by laser etching.

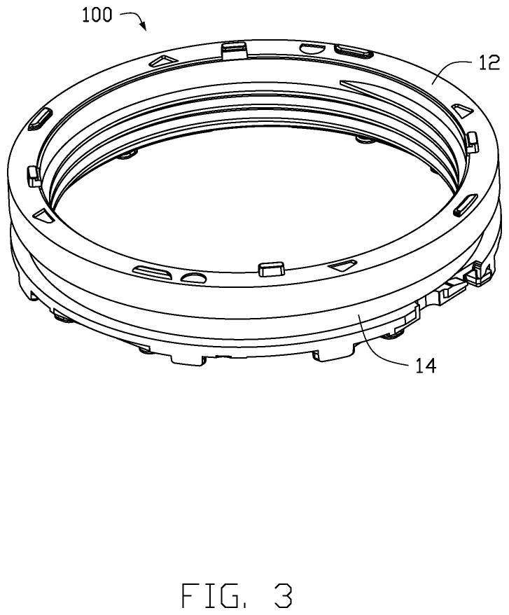

In step S3, electroless plating of metal on the pattern 122 to form a coil 14 (see FIG. 3), thereby producing the composite lens holder 100 (see FIG. 3).

In step S1, the materials of the plastic lens holder comprise a metallic compound and a plastic matrix. The materials of the plastic lens holder 12 are injection molded to form the plastic lens holder 12.

In the embodiment, the metallic compound is a metal organic complex. The metal organic complex is an auxiliary agent for the materials of the plastic lens holder 12 to improve the sensitivity of the materials to the laser. The organic complex is uniformly dispersed in the plastic matrix and releases metal ions during laser etching.

The plastic matrix is a thermoplastic and includes at least one of, but is not limited to, polycarbonate and acrylonitrile-butadiene-styrene copolymer or mixture (PC/ABS), polyurethanes, polyesters, and polycarbonates, preferably includes at least one of polycarbonate (PC), polyadipyl diamine (PA46), polyester resin (PET), industrial liquid crystal polymer (LCP), and poly neighbor Phthalic acid amide (PPA). The plastic matrix is low in sensitivity to laser light beams, and does not deform during laser etching. In the present embodiment, the plastic lens holder 12 is a carrier for carrying the coil 14.

In step S2, specific areas of the outer surface 124 of the plastic lens holder 12 are laser etched to form the patterns 122. In the embodiment, the laser light beam is aligned to the specific areas of the plastic lens holder 12, and such specific areas of the plastic lens holder 12 release metal ions during the laser etching, thereby such specific areas of the plastic lens holder 12 form micro-rough structures with high adhesion potential and enhance the adhesion of the plastic lens holder 12 to the coil 14.

In step S3, electroless plating is performed on specific areas of the plastic lens holder 12 after laser etching. A metal oxide is plated onto the specific areas of the plastic lens holder 12. The metal oxide is reduced and restored to a single metal element to form the coil 14 on the specific areas of the plastic lens holder 12, The metal element is a conductive metal such as copper or silver. The coil 14 generates Lorentz magnetic force upon energization. In the embodiment, laser direct forming technique (“LDS”) is utilized to form the coil 14 on the plastic lens holder 12. Unlike the conventional way of winding a coil on a lens holder, the bonding force between the coil 14 and the plastic lens holder 12 is increased, and the reliability of the composite lens holder 100 is thereby improved.

In the embodiment, the coil 14 is made of copper.

Furthermore, the method may include step S4, forming a metal protective layer on the coil 14. In the embodiment, the metal protective layer can be a nickel layer, a platinum layer, a gold layer, or a layer comprising two or more of nickel, platinum, and gold. The metal protective layer is electroplated to the coil 14. The metal protective layer comprises one or more of nickel, platinum, and gold.

Furthermore, the method may include step S5, performing a surface treatment such as spraying or painting a primer and a top coat, or the like, on the coil 14. The surface treatment prevents oxidation of the coil 14 and improves the durability of the composite lens holder 100. In another embodiment, the method may include either step S4 or step S5, rather than including both S4 and S5.

Referring to FIG: 2 and FIG: 3, in an exemplary embodiment, a mold for forming the plastic lens holder 12 is formed. The material of the plastic lens holder 12 is injected into the mold to shape the plastic lens holder 12. The plastic lens holder 12 is made of a metal organic complex and a thermoplastic matrix. The metal organic complex is an auxiliary agent and the melted thermoplastic is a matrix material. Laser etching is performed on specific areas of the plastic lens holder 12 after injection molding. The metal organic complex in the specific areas releases metal ions to form rough surface patterns 122. A surface finish of the patterns 122 are rougher than a surface finish of other areas of the outer surface 124. The laser-etched plastic lens holder 12 is further subjected to electroless plating to form a coil 14 containing copper on the pattern 122 of the plastic lens holder 12. A layer of metallic nickel is plated on the coil 14 to serve as a protective layer of the coil 14. The surface of the plastic lens holder 12 is further sprayed with lacquer to improve the oxidation resistance of the composite lens holder 100, thereby improving the reliability of the composite lens holder 100.

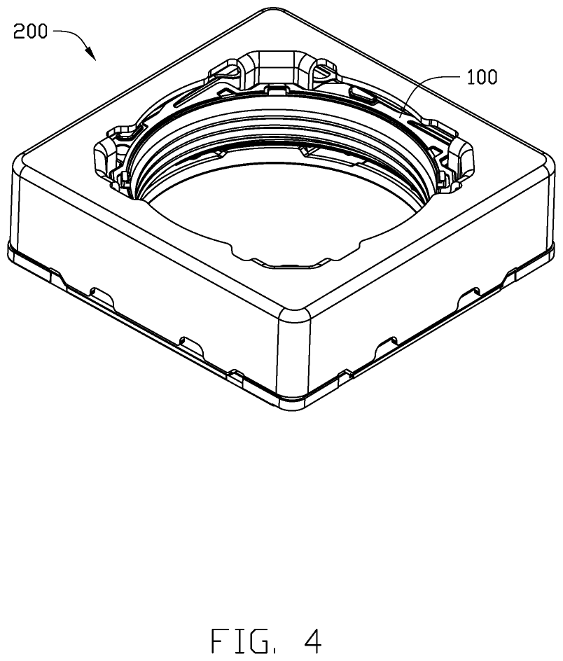

Referring to FIG, 3 and FIG. 4, an embodiment further provides a voice coil motor 200. The voice coil motor 200 includes the composite lens holder 100. The composite lens holder 100 includes a plastic lens holder 12 and a coil 14 formed on the plastic lens holder 12. In the embodiment, the plastic lens holder 12 has a substantially hollow cylindrical structure. The plastic lens holder 12 also has patterns 122 formed on an outer surface 124 of the plastic lens holder 12. The coil 14 is formed on the patterns 122 and covers the patterns 122,

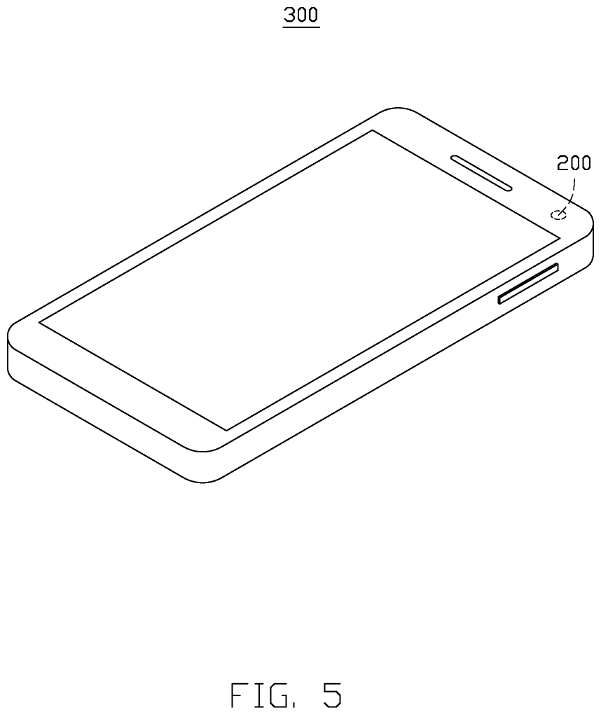

Referring to FIG. 5. an embodiment further provides an electronic device 300. The electronic device 300 includes the voice coil motor 200. The electronic device 300 can be a mobile phone, a camera, a tablet computer, and the like.

The composite lens holder 100 provided by the embodiment forms the coil 14 in specific areas of the plastic lens holder 12, utilizing a laser direct molding technique. The bonding force between the coil 14 and the plastic lens holder 12 is significantly stronger compared with the conventional art. The mass of the coil 14 is reduced, which is beneficial to enhance the torque between the coil 14 and the plastic lens holder 12. The overall weight of the composite lens mount 100 is also reduced, reducing the current load of the voice coil motor 200. The plastic lens holder 12 can be reduced in thickness compared to the conventional art, and fabrication of a smaller size of voice coil motor 200 is facilitated.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size, and arrangement of the parts within the principles of the present disclosure, up to and including the full extent established by the broad general meaning of the terms used in the claims.

What is claimed is:

1. A method for fabricating a composite lens holder, comprising:
forming a plastic lens holder;
forming patterns on an outer surface of the plastic lens holder by laser etching; and
electroless plating of metal on the patterns to form a coil, thereby producing the composite lens holder.

2. The method as claimed in claim 1, further comprising forming a metal protective layer on the coil.

3. The method as claimed in claim 2, wherein the metal protective layer comprises one or more of nickel, platinum and gold.

4. The method as claimed in claim 1, further comprising performing a surface treatment on the coil to prevent oxidation of the coil.

5. The method as claimed in claim 4, wherein the surface treatment comprising spraying or painting a primer and a top coat on the coil.

6. The method as claimed in claim 1, wherein the plastic lens holder is formed by a metallic compound and a plastic matrix, the patterns are formed by metal ions released by the metallic compound during the laser etching.

7. The method as claimed in claim 6, wherein the plastic matrix is a thermoplastic and comprises at least one of polycarbonate and acrylonitrile-butadiene-styrene copolymer or mixture, polyurethanes, polyesters, and polycarbonates.

8. The method as claimed in claim 7, wherein the plastic matrix comprises at least one of polycarbonate, polyadipyl diamine, polyester resin, industrial liquid crystal polymer, and poly neighbor Phthalic acid amide.

9. The method as claimed in claim 1, wherein copper or silver is electroless plated to form the coil.

10. A voice coil motor comprising a composite lens holder, the composite lens holder comprising a plastic lens holder and a coil formed on the plastic lens holder, the plastic lens holder is a substantially hollow cylindrical structure defining an outer surface, the plastic lens holder comprising patterns formed on the outer surface, the coil being formed on the patterns and covering the patterns.

11. The voice coil motor as claimed in claim 10, wherein a surface finish of the patterns is rougher than a surface finish of other areas of the outer surface.

12. The voice coil motor as claimed in claim 10, further comprising a metal protective layer covering the coil.

13. The voice coil motor as claimed in claim 12, wherein the metal protective layer is a nickel layer, a platinum layer, a gold layer or a layer comprising two or more of nickel, platinum, and gold.

14. The voice coil motor as claimed in claim 10, further comprising a primer and a top coat covering the coil, the primer and the top coat preventing oxidation of the coil.

15. An electronic device comprising a voice coil motor, the voice coil motor comprising a composite lens holder, the composite lens holder comprising a plastic lens holder and a coil formed on the plastic lens holder, the plastic lens holder is a substantially hollow cylindrical structure defining an outer surface, the plastic lens holder comprising patterns formed on the outer surface, the coil being formed on the patterns and covering the patterns.

16. The electronic device as claimed in claim 15, wherein a surface finish of the patterns is rougher than a surface finish of other areas of the outer surface.

17. The electronic device as claimed in claim 15, further comprising a metal protective layer covering the coil.

18. The electronic device as claimed in claim 17, wherein the metal protective layer is a nickel layer, a platinum layer, a gold layer or a layer comprising two or more of nickel, platinum, and gold.

19. The electronic device as claimed in claim 15, further comprising a primer and a top coat covering the coil, the primer and the top coat preventing oxidation of the coil.

20. The electronic device as claimed in claim 15, wherein a material of the coil is copper or silver.
